(19) United States
(12) Patent Application Publication
(10) Pub. No.: US 2006/0106626 A1
(43) Pub. Date: May 18, 2006

(54) Method and apparatus of model driven business solution monitoring and control

(76) Inventors: Jun-Jang (JJ) Jeng, Armonk, NY (US); Kumar Bhaskaran, Englewood Cliffs, NJ (US); Hung-yang (Henry) Chang, Scarsdale, NY (US); Tao Yu, Irvine, CA (US)

Correspondence Address: Whitham, Curtis, & Christofferson, P.C.;Suite 340, 11491 Sunset Hills Road, Reston, VA, 20190, US

(21) Appl. No.: 10/988,929

(22) Filed: Nov. 16, 2004

(51) Int. Cl. G06Q 99/00; G06F 17/21

(52) U.S. Cl. 705/1; 715/513

(57) ABSTRACT

A model-driven approach is used in Business Solution Monitoring and Control environment. The solution is first described by the high level abstract Platform Independent Model (PIM), which is independent from platform and implementation technologies. This PIM is presented as a Directed Acyclic Graph (DAG) that is constructed by a series of models described in XML. Then the PIM is decomposed into several sub-processes that can be easily transformed into an executable representation, such as BPEL (Business Process Execution Language) or JAVA. BPEL is used as the example to show the model transformation.

### BACKGROUND OF THE INVENTION

1. Field of the Invention

The present invention generally relates to monitoring and controlling the behavior of business solutions and, more particularly, to a model-driven approach in which business-level monitoring and control requirements are described by a series models that are combined to construct a high level business solution model which can be transformed into an executable representation.

2. Background Description

Business Solution Monitoring and Control are very important in Business Process Management (BPM). It gives business users real-time information about execution status of business process as well as performance evaluation. By having this capability, business users can configure, track and analyze their own defined metrics, Key Performance Indicators (KPIs), and take actions immediately. For example, business managers want to identify and resolve business problems such as whether customer order is delivered promptly, out of stock, etc. Generally, business users that are doing process monitoring and control are divided into three roles:
Business Analyst: Business analyst defines KPIs and metrics that one wants to observe. KPIs and metrics are quantified measurements and may have associated bound or threshold values. An example of KPI can be the cycle time to process customer order. Some KPIs can be calculated from the event data directly, which are considered as low-level metrics. Some high level KPIs, however, are not readily available and must be deduced from lower-level metrics or external data sources. Business analyst also identifies what kind of data/information required is to calculate KPIs.
Data Specialist: Data logics are required to filter, cleanse, and correlate events. Correlation rules (patterns) are used to specify what event patterns need be caught and data carried in them should be extracted.
Operation Manager: Operation manager defines what business situations (or exceptions) must be monitored or controlled as well as actions to be taken when some situation occurs. For example, when a server unreachable exception occurs, monitoring system should send a notification to administrator to ask him restart the server. Or when there is only two hours left to the deadline of customer order, an alert should be sent out.
   Business analyst, data specialist and operation manager work together to design a Business Solution Monitoring and Control system. After system design has been finished, KPIs, correlation patterns, business situations are defined and data sources identified. Traditional development method requires new development whenever a new requirement is produced.

Model-driven architecture, defined by the Object Management Group (OMG), is a new approach to application design and implementation. It helps computer users solve integration problems by supplying open, platform-neutral interoperability specifications (see, for example, “Model Driven Architecture—A Technical Perspective”, OMG Architecture Board model-driven Drafting Team, July 2001). The most significant achievement of this approach is the independence of system specification from the implementation technology. In model-driven architecture, the system specification is described by PIM that is expressed in a platform-independent modeling language, such as UML. The PIM then transformed to a PSM that is expressed by some specific implementation language, such as JAVA or BPEL.

Nowadays, model-driven approach is widely used for information and service integration. J. Siegel in “Using OMG's Model Driven Architecture (model-driven) to Integrate Web Services”, Object Management Group, May 2002, a white paper disclosure developed by OMG, talks about using model-driven to integrate Web services. In a distributed system, it is a big headache to integrate the multiple applications that work together to run a business since applications are using different middleware platforms such as CORBA, COM, EJB, Web Service, etc. Usually, it requires developers skilled in all application implementation technologies to produce a solution. This requirement is too high and too complex to be realized. However, model-driven architecture provides a solution to reduce the pain. Using model-driven architecture, developers only need to describe the solution in high abstract model level, which is platform independent. The model-driven-based tools can automatically transform the PIM into one or more PSMs and applications on one or more middleware platform.

In “Model-driven Architecture Implementation & Metrics”, version 1.1, August 2003, Jorn Bettin from softmetaware gives a detailed comparison for three software development ways: traditional (no abstract modeling), standard UML-based and model-driven-based software development. The comparison results show model-driven is more productive and requires less effort. The advantage of model-driven includes: provides a simpler and easier high abstraction model for developers, reduce the work for code maintenance and can easily make changes with minimal manual effort.

A lot of Business Solution Monitoring and Control tools are developed by different organizations, such as QName! from mqsoftware (“Real-Time Business Transaction Monitoring”, product introduction in mqsoftware), Transaction Vision from Bristol Technology (Transaction Vision product information in Bristol Technology), etc. As part of business process management, business monitoring and control provides the ways to supervise runtime operation, analyze process performance and aggregate process audit trail data. The benefit brought by monitoring and control include lower the process cost and faster the process execution.

BPEL (F. Curbera, Y. Goland, J. Klein, F. Leymann, D. Roller, S. Thatte and S. Weerawarana, “Specification: Business Process Execution Language for Web Services, Version 1.1, May 2003) provides a language for formal specification of business processes and business interaction protocols. It can model the behavior of executable and abstract process. Most modeling tools and development tools provide native support for BPEL as the standard file description for the business process.

“Automating Business Process Management with BPEL and XML”, a white paper disclosure of PolarLake, describes how to use BPEL and XML to automate business process management. This white paper disclosure looks at the business and technical drivers behind BPM and BAM (Business Activity Monitoring) and show how BPEL can be used to make it easier for business to define, orchestrate and deploy business processes both within and between organizations.

### SUMMARY OF THE INVENTION

We apply the model-driven approach in business process management monitoring and control system to provide an effective, reliable and rapid solution. Because of the widely support of BPEL by development and modeling tools, we choose it as the target PSM in a model-driven architecture.

According to one aspect of the invention, a model-driven approach is used to monitor and control the behavior of business processes. The business-level monitoring and control requirements are first described by a series of models, each of which is a light-weight specification describing a single of monitoring and control system, e.g., metric calculation, action etc. These models can be combined together to construct a Directed Acyclic Graph (DAG), which can be regarded as the Platform Independent Model (PIM) for the high-level business solution. The PIM provides a convenient and clear way for business users to understand, monitor and control the interactions in the target business process. Then the PIM is transformed to an executable representation (Platform Specific Model, PSM), such as BPEL (Business Process Execution Language for Web Service) by decomposing the DAG into several sub-processes and modeling each sub-process as a BPEL process that will be deployed at runtime.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block and schematic diagram illustrating the model-driven approach for business solution monitoring and control;

FIG. 2 is a block diagram showing the model interface matching condition;

FIG. 3 is a block diagram showing a sub-process;

FIG. 4 is a block diagram showing a business process decomposition;

FIG. 5 is a block and flow diagram illustrating the BPEL process for rule Match;

FIG. 6 is a block and flow diagram illustrating the BPEL process for rule Block Duplicate;

FIG. 7 is a block and flow diagram illustrating the BPEL process for rule Sequence;

FIG. 8 is a block and flow diagram illustrating the BPEL process for rule Timer;

FIG. 9 is a data flow diagram showing a high-level description of a gold customer order delayed example;

FIG. 10A is a data flow diagram of the PIM for the gold customer order delayed example, and FIG. 10B is a data flow diagram of sub-processes for the example;

FIG. 11 is a block and flow diagram illustrating the BPEL process for rule Item Out of Stock;

FIG. 12 is a block and flow diagram illustrating the BPEL process for rule Procurement Order;

FIG. 13 is a block and flow diagram illustrating the BPEL process for rule Supplier Confirmation;

FIG. 14 is a block and flow diagram illustrating the BPEL process for rule Customer Order;

FIG. 15 is a block and flow diagram illustrating the BPEL process for rule Gold Customer Order Delayed; and

FIG. 16 is a block diagram of a system on which the invention may be implemented.

### DETAILED DESCRIPTION OF A PREFERRED EMBODIMENT OF THE INVENTION

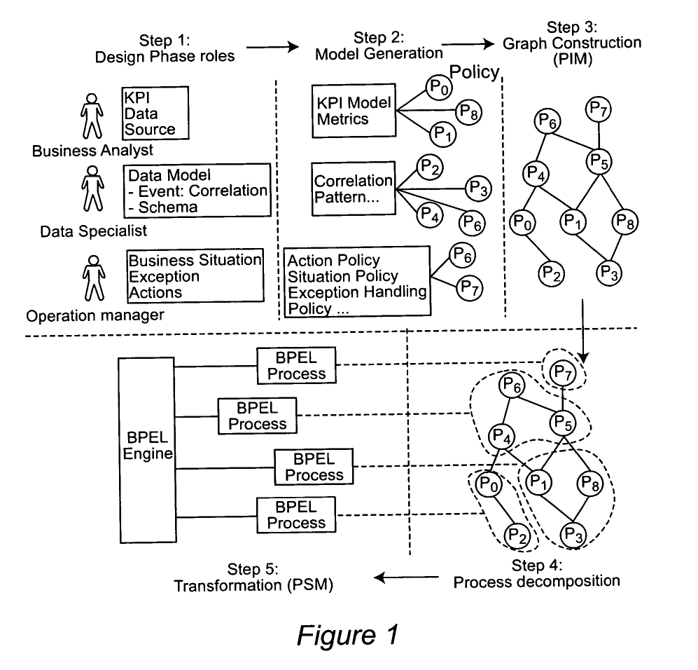

The steps of using model-driven approach for business monitoring and control system are shown in FIG. 1. Detailed information will be provided in following sections.
Step 1. Business design phase where different roles define the subset of the monitoring and control solution at the business level such KPI calculation rules, data sources, correlation logic, action rules;
Step 2. Model generation phase where system designers create a set of models for KPIs, situation detection and correlation patterns based on the information given in step 1;
Step 3. Composition Phase where the system constructs DAG by composing those models defined in Step 2. This DAG is the PIM for high level business solution, which provides a convenient and clear way for business users to understand, monitor and control the behavior of the managed business process;
Step 4. Decompose Phase where the system decomposes the generated DAG from Step 3 into several sub-processes that are transformable to executable modules in the target platform; Step 5. Transform Phase where each sub-process is transformed into an executable module. In this disclosure, BPEL is used as the example of such modules. Each BPEL process can be wrapped as a service and they can communicate with each other through event bus. By doing so, the PIM (models) can be transformed into PSM (BPEL) that can be executed by an executable runtime engine.
   Using model-driven approach to generate monitoring and control solution for business processes musters following advantages:
Save cost and reduce development time.
Monitoring and control solution can be defined at the business process level without being burdened by implementation detail of target platform. There is no need of navigating through development lifecycle.
Increase the software quality
   The transformation algorithm to transform PIM to executable representation is similar to language compilers that translate the higher-level instructions into native processor instructions, which can be interpreted by the machine. Once the transformation tool has been well developed and thoroughly tested, it can be reused and the quality of the software generated by it can be guaranteed.

MDA (R. Soley and OMG Staff Strategy Group, “Model Driven Architecture”, November 2000) is a framework for software development. Models and model driven software development are the key elements in model-driven. The typical model-driven process includes three steps:
1. Build a model with high level abstraction. This model is a PIM that is independent of any implementation technology. In our Business Solution Monitoring and Control system, the PIM is the DAG constructed by a set of models as shown in step 3 of FIG. 1;
2. Transform PIM into one or more PSM. A PSM is related to a specific implementation technology, such as J2EE model, EJB model. In our system, we choose BPEL process as target PSM;
3. Transform PSM to code to be executed by machine. This step is usually completed by the implementation technology related to the PSM. In our system, BPEL process is interpreted and executed by a BPEL engine.
   Now we will present detailed information about how to transform PIM to PSM in our system as shown in FIG. 1. Since the PIM in our system is constructed by a set of models, we first take a look at model description.

There are three groups of models defined by business analyst, data specialist and operation manager: KPIs expressions, Correlation rules and Action models.

A KPI expression is made up of parameters and operators. Based on parameter data types in KPI, there are several categories of operators: Boolean, Arithmetic, Relational, Set, String, Calendar, Vector and etc. Table 1 shows some common operators in each category. Some Examples of KPIs are the following:
Daily_revenue=Average (Revenues in last 30 days)
   Supplier_Response_time=
   Supplier_Response_Event.timestamp—Supplier_Receive-Order_Event.timestamp
Server_Down=(Count (Server_down_events)>30) within 30 seconds

Usually KPI/Metrics are defined within a specific business situation that defined by operation manager. Table 1 tabulates operators in KPI/Metrics.

TABLE 1

| Category | Operators |
|---|---|
| Boolean | AND, OR, XOR, NOT |
| Relational | >, <, >=, <=, ==, != |
| String | Begins, Contains, Ends, Like, Length |
| Calendar | isAfter, isBefore, isWithin |
| Set | Belongs, Union, Intersect, Less |
| Vector | Min, Max, Mean, Sort, Count, Average, SD |
| Arithmetic | +, −, *, /, Remainder, log, Exp, Pow, Sqrt, Abs, Round, |
| | Floor, Rint, Ceiling |

Business processes interact with one another and the environment through events. Events are captured by Business Solution Monitoring and Control system. Many of the captured events are meaningless to specific monitoring and control system while others need to be considered in a specific pattern. Correlation rules (patterns) are used to specify the event patterns that need be caught and data carried in them should be extracted according to requirements.

The definition of a correlation rule includes a number of rule-specific parameters (such as threshold, time period), event selection criteria to select events that relevant to the rule and actions should take (defined by action model) once the rule fires (A. Bussani, M. Feridun, “Zurich Correlation Engine (ZCE)—Rule and Predicate Specification Document”, Jun. 12, 2003).

We define seven basic correlation rules for our system: Match, Block Duplicates, Update Last, Collection, Threshold, Sequence and Sequence Absence. Match is the only stateless rule, in which event are treated independently. All the others are stateful, in which events rely on previous detected events and they depend on each other. These rules are defined based on IBM Zurich Correlation Engine rule definition (see Bussani et al., supra). Correlation rules can be defined using XML syntax. The format of rule definition is shown below.

CORRELATION RULE DEFINITION

| | |
|---|---|
| <rule id = “rule identification”> | --- Rule identifier |
| <rule type [attributes]> | --- Rule Type |
| <selection criteria> | --- Event selection criteria |
| ....... | |
| </selection criteria> | |
| </rule type> | |

```
        <action model = “model name”> --- Actions to take, defined by
        action model
    ......
    </action>
</rule>
```

Table 2 shows definitions for seven basic correlation rules.

TABLE 2

| Rule Type | Description | Definition |
|---|---|---|
| Match | Filter out the individual event | < rule id = “rule.match”> |
| | that matches the selection | <match> |
| | criteria. Once the event has been | <criteria>event = ServerUnreachable |
| | detected, an action will be taken. | </criteria> |
| | | </match><action model = |
| | | “NotifyAdmin”> |
| | | ...... |
| | | </action> |
| | | </rule> |
| Block | Block forwarding of duplicate | < rule id = “rule.block_duplicate”> |
| Duplicates | events within a specified time | <block_duplicate timeinterval = |
| | period. When the first matching | “10000”> |
| | event has been detected, an | --- Block duplicate events for 10 |
| | action will be taken. All the | seconds |
| | following duplicate events will | <createInstance = “Yes” attributeSet |
| | be blocked. | = “SeverName”/> |
| | | --- New instance of rule will be created |
| | | if there is no such rule exists for the server |
| | | with name = “ServerName” |
| | | <criteria>event = ServerUnreachable |
| | | </criteria> |
| | | </block_duplicate><action model = |
| | | “SendEvent”> |
| | | ...... |
| | | </action> |
| | | </rule> |
| Update Last | Forward the last individual event | < rule id = “rule.update_last”> |
| | that matches selection criteria in | <update_last timeinterval = “10000”> |
| | a specified time period and | <createInstance = “Yes” attributeSet |
| | ignore all the previous ones. | = “SeverName”/> |
| | When the time expired, an action | <criteria>event = ServerUnreachable |
| | will be taken. | </criteria> |
| | | </update_last> |
| | | <action model = “SendEvent”> |
| | | ...... |
| | | </action> |
| | | </rule> |
| Collection | Collect all the individual events | < rule id = “rule.collection”> |
| | that match the selection criteria | <collection timeinterval = “10000”> |
| | over a period of time. When the | <createInstance = “Yes” attributeSet |
| | time expired, an action will be | = “SeverName”/> |
| | taken. | <criteria>event = ServerUnreachable |
| | | </criteria> |
| | | </collection> |
| | | <action model = “SendAllEvents”> |
| | | ...... |
| | | </action> |
| | | </rule> |
| Threshold | Collect the individual events that | < rule id = “rule.threshold”> |
| | match the selection criteria | <threshold timeinterval = “10000” |
| | within a period of time until a | threshold = “10”> |
| | threshold value is reached. The | --- If more than 10 events that match the |
| | threshold can be based on | criteria have been detected, an action will |
| | number of collected events or | be taken |
| | aggregation of a value. When the | <createInstance = “Yes” attributeSet = |
| | threshold has been reached, an | “SeverName”/> |
| | action will be taken. | <criteria>event = ServerUnreachable |
| | | </criteria> |
| | | </threshold> |
| | | <action model = “SendAggregation”> |
| | | ...... |
| | | </action> |
| | | </rule> |
| Sequence | Detect a sequence of events | < rule id = “rule.sequence”> |
| | within the time interval. The | <threshold timeinterval = “10000” |
| | events in the sequence are | RandomOrder = “false”> |
| | defined by a set of event | --- events must be detected in specified |
| | selection criteria. There are two | order |
| | modes of detection: (1) Detect | <createInstance = “Yes” attributeSet = |
| | events in order; Events must be | “OrderNumber”/> |
| | detected in specified order. (E1, | <criteria> |
| | E2, E3); (2) Detect events | Event1 = receive customer order |
| | randomly; Events can be detected | Event2 = order response |
| | in any order. (E1, E2, E3; E1, E3 | Event3 = ship notice |
| | E2). When the complete | --- must detect these 3 events in this order |
| | sequence of events has been | (1,2,3) |
| | detected with the time window, | </criteria> |
| | an action will be taken. | </threshold> |
| | | <action model = |
| | | “Sendeventssequence”> |
| | | ...... |
| | | </action> |
| | | </rule> |
| Sequence | Detect a sequence of events | < rule id = “rule.sequence_absence”> |
| Absence | within the time interval. The | <threshold timeinterval = “10000” |
| | events in the sequence are | RandomOrder = “true”> |
| | defined by a set of event | --- events can be detected in any order |
| | selection criteria. There are two | <createInstance = “Yes” attributeSet = |
| | modes of detection: (1) Detect | “OrderNumber”/> |
| | events in order; (2) Detect events | <criteria> |
| | randomly. When the time | Event1 = confirmation for customer A |
| | expired, and defined event | Event2 = confirmation for customer B |
| | sequence hasn't been detected, an | Event3 = confirmation for customer C --- |
| | action will be taken. | 3 events can be detected in any order |
| | | </criteria> |
| | | </threshold> |
| | | <action model = “SendMissingevents”> |
| | | ...... |
| | | </action> |
| | | </rule> |

Action model provides model rules for system behavior in response to defined business situation. A simple example of action model is send notification to administrator once server unreachable event has been detected by correlation rules defined above.

Action model can also be defined using XML syntax. The definition of action model includes a number of model-specific parameters, the target of the model—messages generated by action model will be sent to the defined target, a series of KPIs used by model (defined by KPI expression), a set of correlation rules that triggered this model (defined above) as well as actions will take once the model has been triggered.

FORMAT OF ACTION MODEL DEFINITION

| | |
|---|---|
| <model name = “model name”> | ---- model name |
| <parameters> .... </parameters> | ---- parameters will be used in |
| | model |

<target> .... </target> ---- where the message generated

| | |
|---|---|
| | by action model should be |
| | sent |
| <metrics> .... </metrics> | ---- metrics used by model |
| <correlation rules> | ---- correlation rules that trigger |
| | the model |

```
        <rule id = “”>... </rule>
    </correlation rules>
```

| | |
|---|---|
| <action list> | ---- actions will take |

```
    <action function = “function name”>
    ....
    </action>
    ....
    </action list>
</model>
```

An example of action model is given below. This model sends a notification to system administrator when a custom order can not be shipped on time. This model is triggered by Sequence correlation rule. When events customer_order (E1), order_confirmation (E2) and supplier_response (E3) that contains the same order number have been detected in order (E1, E2, E3), this model will be triggered. The parameters needed in the model customer_order_message, order_confirmation_message and supplier_response_message that are carried by events. Once the model is triggered, the metrics with relational operator will compare the shipping date provided by supplier with due_date required by customer. If the shipping date is later than due date, a notification will be sent to system administrator.

### Action Model Example

```
<model name = “sensecustomerorderdelayedsituation”>
  <parameters>
      Customer_order {Customer_name; Order_number;
      Due_date; }
      Order_confirmation {Order_number; supplier_id;}
      Supplier_response {supplier_id; order_number; shipping_date;}
  </parameters>
  <target>
      System Administrator
  </target>
  <metrics>
      supplier_response. Shipp_date > Customer_Order. Due_date
  </metrics>
  <correlation rules>
    <rule id = “rule.sequence”>
      detect customer_order, order_confirmation,
      Supplier_response events
      in order, messages are correlated by order_number
    </rule>
  </correlation rules>
  <action list>
    <action function = “Send notification”>
      Send a notification message to system administrator to report
      customer order with id = OrderNumber can not be shipped
      in time from supplier with ID=supplier_id.
    </action>
</action list>
</model>
```

In a Business Solution Monitoring and Control system, business analyst, data specialist and operation manager define different models (Metrics, correlation rules and action models) for a business situation. After all models have been defined, we will combine them together to construct a DAG as the PIM for high level business solution, as shown in step 3 of FIG. 1.

The question is: How to combine different models into a DAG? Which models should be connected to each other? Suppose each model has a set input and Output interface definitions describing the message formats it can accept and generate, finding model pairs is to match an input and an Output interface definition of two models.

This problem is quite similar to the service composition problem in Web service field, where we need to integrate different services into a business process. A lot of researches have been done in semantic web service composition (see, for example, R. Zhang, B. Arpinar and B. Aleman-Meza, “Automatic Composition of Semantic Web Services”, The First International Conference on Web Services (ICWS'03), Las Vegas, Nev., Jun. 23-26, 2003, and K. Fujii and T. Suda, “Loose Interface Definition: An Extended Interface Definition for Dynamic Service Composition”, Proc. of the First Annual Symposium on Autonomous Intelligent Networks and Systems, Los Angeles, Calif., May 2002). We can adopt their ideas to do the model matching.

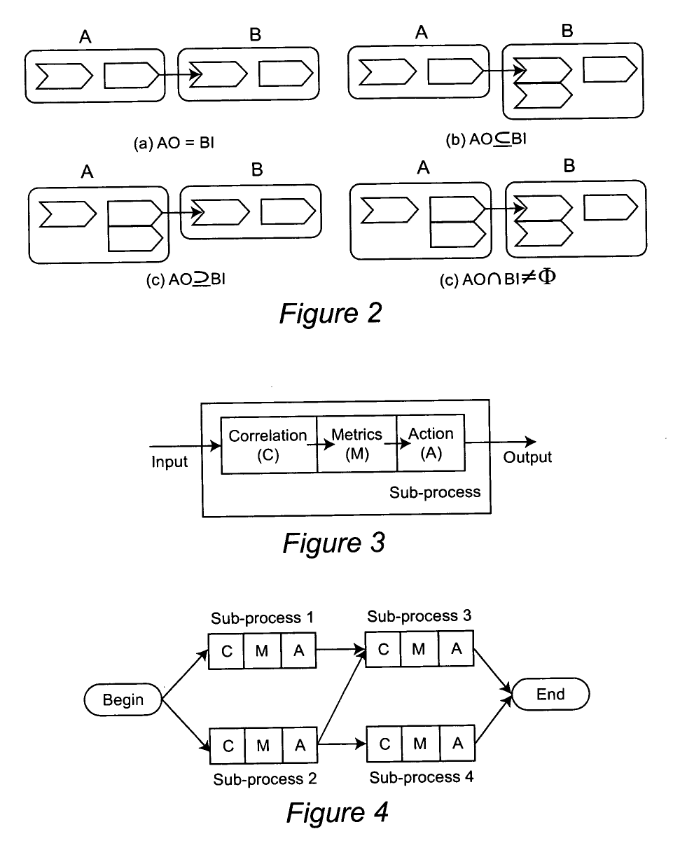

Currently, we are just doing some simple interface match checking. In following four conditions, we consider two models' interfaces are matching. More matching conditions will be added in our future work. (AO: Output of model A, BI: input of model B):
1. If AO==BI, match successful; (FIG. 2(a))
2. If AO⊂BI, match successful; (FIG. 2(b))
3. If AO⊃BI and the matching part can be separated out from AO, match successful. (FIG. 2(c)).
4. If AO∩BI≠Ø and the matching part can be separated out from AO and also from BI, match successful. (FIG. 2(d))
   The similarities of two models interfaces are decreased from condition 1 to condition 4.

If two models interfaces match successfully, we can add a directed link (from model A's Output to model B's input) between them. Considering each model as a node, a graph can be constructed by adding links between all the matching model pairs. And because the special features of business process monitoring system, it must be a DAG. If there is a loop existing in the constructed graph, we can remove the link that has the minimal similarity in the loop and continue this step until there is no loop in the graph. This DAG is the PIM for high level business solutions.

We have presented models definitions and interface matching conditions for constructing a DAG (PIM) by connecting model pairs. Now we need to transform the PIM (Platform Independent Model) into one or more PSM (Platform Specific Model). We choose BPEL (Business Process Execution Language) as our target PSM. Usually, it is too complicated to present the entire PIM by just one BPEL process. The first thing we need do is to divide the DAG into several parts, each part is a sub-process and can be transformed into a BPEL process. This is called process decomposition. For example, we can decompose the DAG shown in step 3 of FIG. 1 into four sub-processes, as shown in step 4. The sub-process 1 contains model P1, P3 and P8, sub-process 2 contains model P0 and P2, sub-process 3 contains model P4, P5, P6, while sub-process 4 contains model P7.

There are some issues we need consider during process decomposition:
1. Are there any criteria for establishing a bottom level process component? Which means, how do we decide when to stop the process decomposition?
2. If there exists more than one way to do the decomposition and generate different sets of sub-processes, which one is the best?
   The reason for process decomposition is because it is too difficult to transform the entire complicated PIM into one executable presentation (one BPEL process). So the basic criterion for decomposition is to make sure after decomposition, each sub-process can be presented by a BPEL process and all produced BPEL processes can communicate each other to achieve the original objective. In a simple word, process decomposition can be stopped when each sub-part is presentable.

Currently, we only define some basic rules to do process decomposition:
1. Each model must be included in at least one sub-process; Some models can reside in more than one sub-processes;
2. Each sub-process contains at least one correlation rule, one KPI/metric expression and one action model, as shown in FIG. 3. The correlation rule takes inputs from outside or from the Output of other sub-processes and passes them to metrics for some calculation. The results produced by metrics expressions will be passed to action model and take the predefined actions to generate Outputs.
3. Decomposition based on correlation rules:

Correlation rules are the foundation of the whole system. Metric calculations are based on the information carried in events that are caught by correlation rules and action models are also triggered by correlation rules. So in process decomposition, we can do the division based on the correlation rules. Each rule can be considered as a beginning of a sub-process, and the metrics and action model related to the correlation rule will be added to generate a complete sub-process.
4. Combine some small simple sub-processes to be a new bigger sub-process:

For all the sub-processes constructed on correlation rules, some of them are very simple. For example, the sub-process that contains Match correlation rule may only filter some special events out and extract the message from the event and assign to another variable, finally, the message will be sent out to another sub-process by action model. If there are two sub-processes with Match rules, one takes the other one's Output as its input, we can combine them into a new bigger sub-process that contains two Match rules.

FIG. 4 shows what the system looks like after decomposition. Four sub-processes have been generated and each of them will be transformed to a BPEL process. There is always a tradeoff between the complexity of each sub-process and the efficiency of the whole system. If you divide whole system to very detailed degree, each sub-process only do a simple work but there are lots of sub-processes exist and they must communicate with each other to achieve the original objective. In this case, system efficiency is decreased by large amount of communications and message exchanges among sub-processes. On the other hand, if you only divide whole system to a few sub-processes, each sub-process need do a lot of work and make them to be complicated. But there are less communications and message exchanges and the system turns to be more efficient.

The detailed information and algorithms for process decomposition will be reported in our future work. In this invention, we focus at how to use BPEL to model each sub-process. For each sub-process, metrics expression and action models are relatively easier to be modeled (by <assign>, XPATH function, <Invoke> . . . ). The main effort lies on modeling correlation rules in BPEL.

We will now show how to model basic correlation rules (described above) in BPEL. The seven basic correlation rules are Match, Block Duplicates, Update Last, Collection, Threshold, Sequence and Sequence Absence. Due to the space limit, we only show the BPEL process for rules Match, Block Duplicates and Sequence.

We define four partners in the BPEL process:
Process Initializer: This is a virtual partner created in order to start/stop BPEL process;
Monitor: Continuous sending events to BPEL process;
Timer: An outside timer is created for each group of events that have the same correlation ID (“attributeSet” in correlation rule definition, see 2.1.2). When a SetTimer message is sent to the timer partner by BPEL process, a timer is initiated with the specified time duration. Once the timer expired, a TimeExpired will be sent back to BPEL process. Some actions can be taken by BPEL process after receiving this message (e.g. metric calculation).
Admin: Receive notification message from BPEL process.

Messages exchanged between BPEL process and above partners have one of following types:

| Message Type | Contents | Direction | Description |
|---|---|---|---|
| InitializeMsg | int command; | Process | Start/stop BPEL process |
| | (1: start; 0: stop) | Initializer → | |
| | | BPEL | |
| EventsMsg | int msg_id; | Monitor → | msg_id: correlation ID. |
| | String msg_contents; | BPEL | Used by BPEL to divide |
| | | | events into different groups |
| SetTimerMsg | int msg_id; | BPEL → Timer | Start timer for events with |
| | int duration; | | same msg_id |
| TimerExpired | int msg_id; | Time → BPEL | Inform BPEL the timer |
| Msg | | | with this msg_id has |
| | | | expired |
| NotifyMsg | int msg_id; | BPEL → Admin | Report a specified situation |
| | String notify_contents; | | has been detected for the |
| | | | group of events with same |
| | | | msg_id |

Except rule Match, all other correlation patterns are stateful and events with same correlation ID (msg_id) need to be correlated. In order to achieve this purpose, we define an internal variable with array type to record the status for event groups. The definition for the internal variable is different for different correlation rules.

The Rule Match (Filter) filters out the individual event that matches the selection criteria. Once a matching event has been detected, a notification will be sent to Admin. The variables definitions are as follows:

| Name | Type |
|---|---|
| Initialization | IntializeMsg |
| Event | EventsMsg |
| Notification | NotifyMsg |

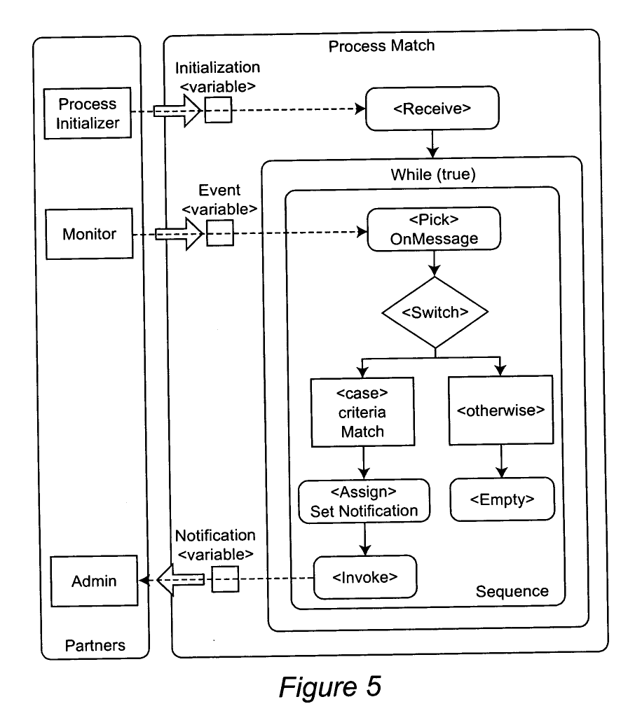

BPEL process for rule Match is shown in FIG. 5.
1. The process is started by receiving “start process” command from partner “Process Initializer” (command=1 in Initialization variable) through <Receive> activity defined by BPEL;
2. Process keeps running to receive events messages from “Monitor” through <Pick>;
3. A <Switch/Case> is used to check whether the received event matches the selection criteria;
4. If event matches the selection criteria, contents of notification will be set by <Assign> activity and sent out to “Admin” through <Invoke>;
5. Go back to Step 2 and repeat Step 2-4 to detect all events that match the selection criteria.

Rule Block Duplicates provides block forwarding of duplicate events within a period of time. When the first event that matches the event selection criteria has been detected, a notification message will be sent to Admin. All the following duplicate events will be ignored for a period of time. The variables definitions are as follows:

| Name | Type |
|---|---|
| Initialization | IntializeMsg |
| Event | EventsMsg |
| SetTimer | SetTimerMsg |
| TimerExpired | TimerExpiredMsg |
| Notification | NotifyMsg |
| EventGroup* | int [ ] |

*Internal variable, records msg_id for detected events. Incoming events with msg_id exists in this array will be blocked.

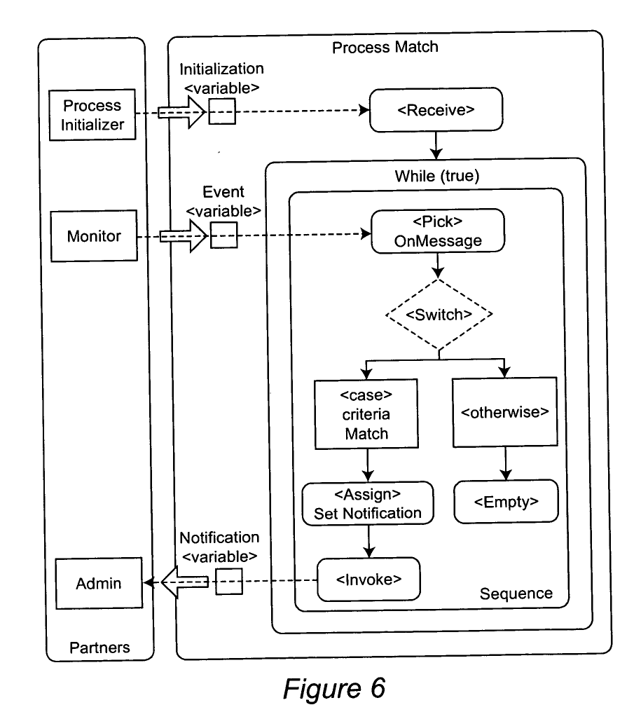

The BPEL process for rule Block Duplicates is shown in FIG. 6.
1. The process is started by receiving “start process” command from partner “Process Initializer” through <Receive> activity. Then it initializes the internal variable “EventGroup” by using <Assign>; After initialization, two <while> loops are running in parallel: <While> loop A:
2. Process keeps running to receive events messages from partner “Monitor” through <Pick>;
3. The first <Switch/Case> is used to check whether the event matches the selection criteria and the second <Switch/Case> is used to check whether the msg_id contained in the event already exists in “EventGroup” array. If exists, skip step 4 and go to step 5. Otherwise the event is the first matching event for this msg_id, go to step 4;
4. Once the first matching event has been detected, the msg_id contained in the event is appended to variable “EventGroup” and a timer with specified duration is started by calling the external timer process through <Invoke>. It also sets the notification message contents and send the notification to “Admin” by the second set of <Assign> and <Invoke>;
5. Go back to Step 2 and repeat above process.
   <While> Loop B:
2. At the same time of receiving events messages from partner “Monitor”, the process is also waiting for the timer expired message from partner “Timer”. Once a timer expired message is received through <Receive>, the <Assign> activity is used to delete the msg_id contained in timer expired message from “EventGroup” array to remove the blocking for events with this msg_id;
3. Repeat Step 2.

Rule Sequence detects a sequence of events within the time interval. The events in the sequence are defined by a set of event selection criteria. There are two modes of detection: (1) Detect events in order; Events must be detected in the specified order (E1, E2, E3). (2) Detect events randomly; Events can be detected in any order. (E1, E2, E3; E1, E3 E2; etc). When the complete sequence of events has been detected within the time window, a notification will be sent to Admin. The variables definitions are as follows:

| Name | Type |
|---|---|
| Initialization | IntializeMsg |
| Event | EventsMsg |
| SetTimer | SetTimerMsg |
| CancelTimer | TimerExpireMsg |
| TimerExpired | TimerExpiredMsg |
| Notification | NotifyMsg |
| EventGroup1* | int [ ] |
| EventGroup2* | int [ ] |

*Internal variable, records msg_id for detected events. If n events need be detected in sequence (whatever in order or random order), n variables will be defined, one for each event detection.

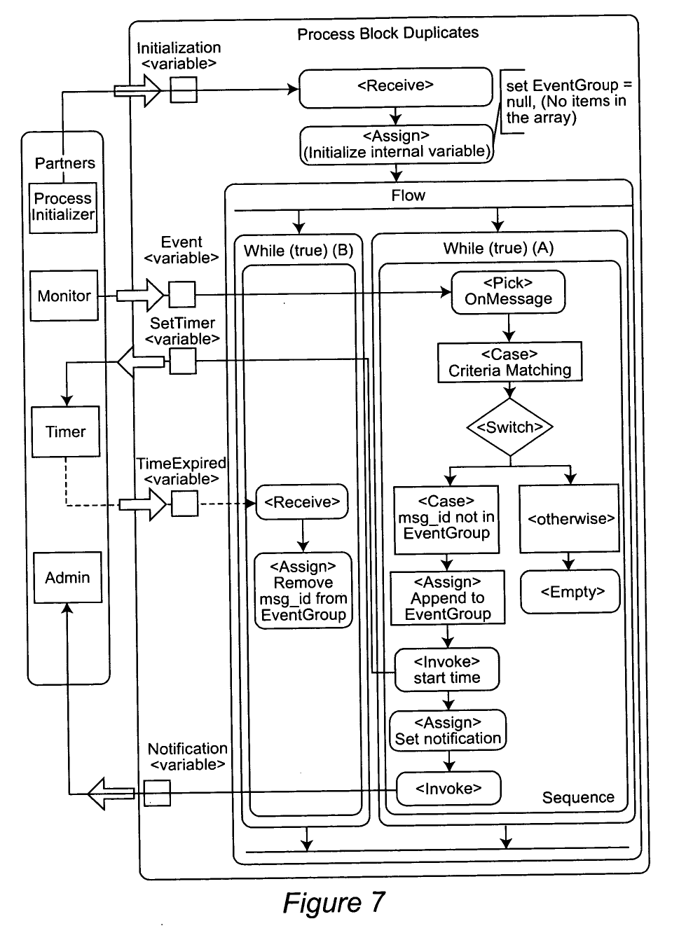

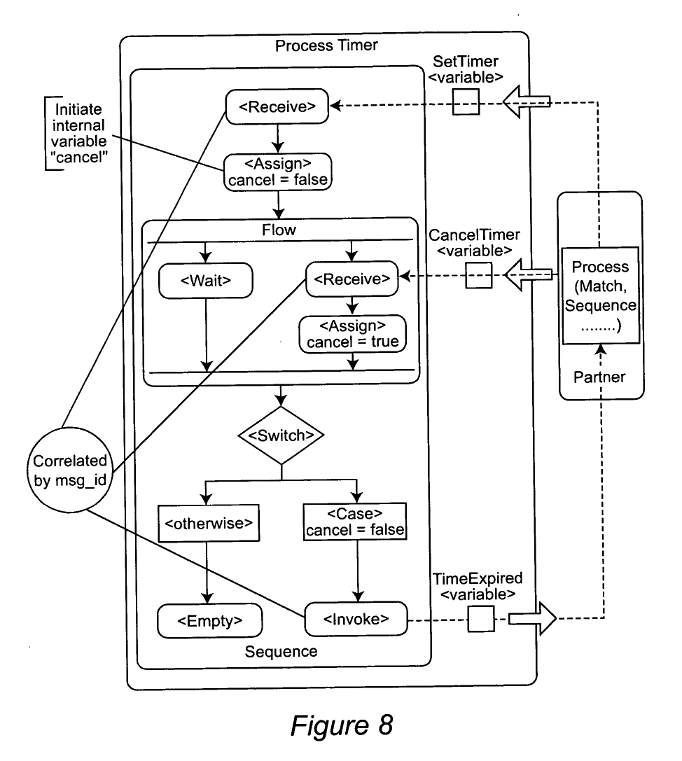

The BPEL process for rule Sequence is shown in FIG. 7.
1. The process is started by receiving “start process” command from partner “Process Initializer” through <Receive> activity. Then it initializes the internal variable “EventGroup” by using <Assign>; After initialization, two <while> loops are running in parallel: <While> loop A:
2. Process keeps running to receive events messages from partner “Monitor” through <Pick>;
3. A <Switch/Case> is used to check whether the event matches the selection criteria for any of the events in the events sequence that we need identify. If no match has been found, go back to step 2 (this part has been ignored in FIG. 10 due to the space limit);
4. If the event matches one selection criteria (e.g. criteria for event 1), another <Switch/Case> is used to check whether the msg_id contained in the event already exists in “EventGroup 1” array. If exists, do nothing. Otherwise append it to “EventGroup I” array by using <Assign> activity;
5. Another <Switch/Case> is used to check whether event 2 with same msg_id has already been detected by checking msg_id in “EventGroup2” array. If it exists, go to step 6. Otherwise go back to step 2;
6. At this point, all the events in the sequence have been detected. We need to:
   a) Cancel previously set Timer by invoke external timer process and send “CancelTimer” message with specifid msg_id through <Invoke>;
   b) Set contents of notification message and send to partner “Admin” by <Assign> and <Invoke>;
   c) Remove msg_id from “EventGroup1” and “EventGroup2” array by another <Assign>;
7. Go back to Step 2 and repeat Steps 2-6.
   <While> Loop B:
2. After process initialization, a timer with specified duration is set by calling external timer process through <Invoke>;
3. Waiting for timer expired message. Once a timer expired message has been received by process through <Receive>, go to step 4;
4. Set contents of notification message and send to partner “Admin” by <Assign> and <Invoke>;
5. Repeat Steps 2-4.

The Timer partner can also be implemented by a BPEL process, as shown in the FIG. 8. An internal variable “Cancel” is defined for the process. It is initiated to be “false” after the process started. The BPEL process is as follows:
1. The Timer BPEL process is instantiated when a SetTimer message with msg_id that is different than all existing process instances' msg_id has been received through <Receive>;
2. Internal variable “Cancel” is initialized to be “false” by <Assign> activity;
3. Two kinds of activities are executed in parallel:
   a) Wait for specified time period to expire. (<wait>);
      b)<Receive> CancelTimer message, once received, <Assign> “Cancel” to be “true”.
4. Using <switch/case> to check “cancel=true” or not. If yes, do nothing. Otherwise, send TimerExpired message back to process who set the timer by <Invoke>.
   For each msg_id, there is a Timer process instance. The <receive> and <Invoke> activities are correlated by msg_id.

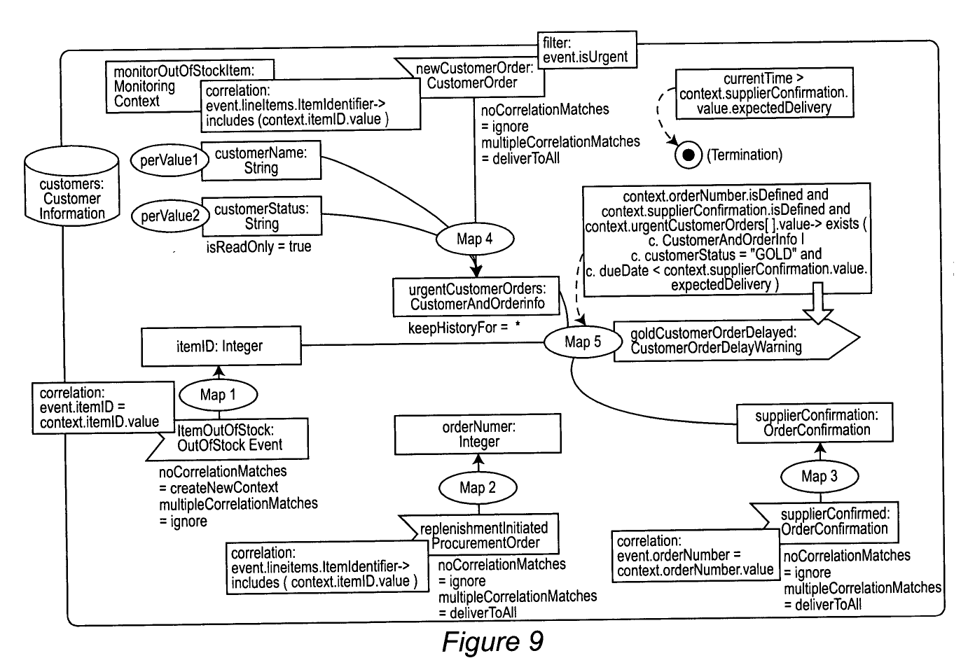

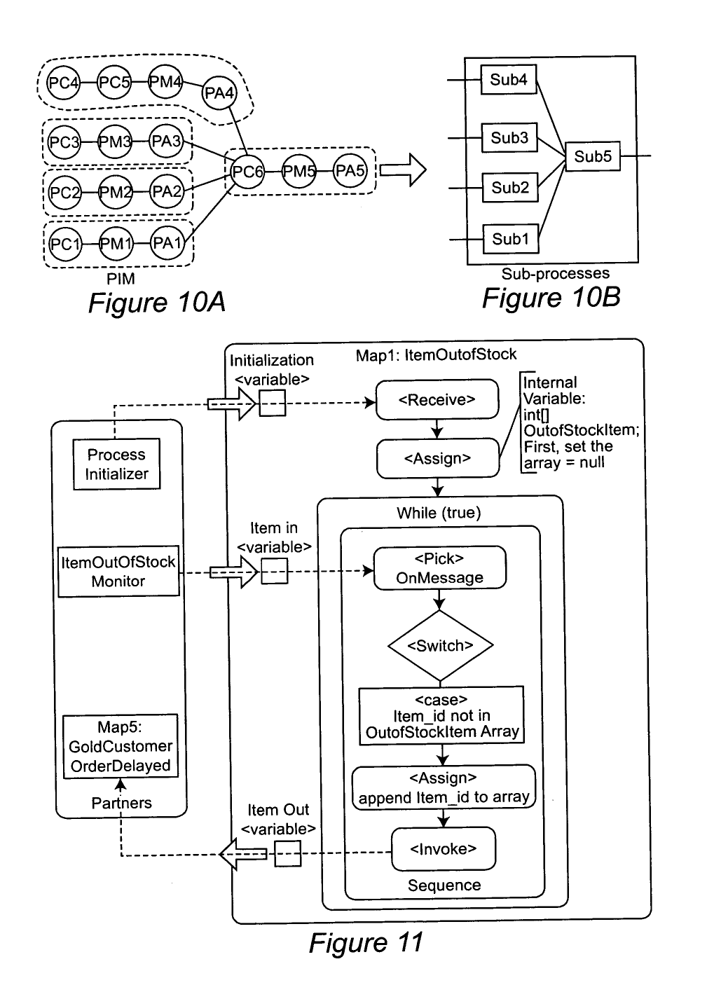

We now use an example to show how we can use this model-driven approach in business performance monitor and control system. The example we use is taken from Business Operation Metamodel (BOM) specification defined by IBM. This example describes that a notification should be sent (CustomerOrderDelayed) to the Administrator when an urgent order arrives from a gold-level customer, requesting an out-of-stock item, a replenishment order for the item has been issued, and the expected delivery date is later than the due date of the customer order. FIG. 9 shows the high level description of the example.

There are 5 maps defined in FIG. 8 (taken from BOM, IBM). Maps 1-4 get input data from different outside partners and extract the useful information that will be used by Map 5:
Map 1: Takes input data from outside monitor that contains the ItemOutOfStock information and extracts the Item_id;
Map 2: Takes input data from outside monitor that contains the ProcurementOrder information, and gets the OrderNumber and lineItems[ ], which included a series of Item_id that will be replenished;
Map 3: Takes input data from outside monitor that contains the SupplierConfirmation information and gets the OrderNumber and Expecteddeliverydate;
Map 4: Takes input data from customer that contains the CustomerOrder information, and extracts Customer_id, Item_id, DueDate, etc;
Map 5: The input data of Map 5 comes from Maps 1-4, Map 5 compares the expect delivery date of an item, which is got from Map 3, with the Duedate of the item that is requested by the customer, which is got from Map 4. If the delivery date is later than the DueDate, a warning message (GoldCustomerOrderDelayed) will be generated and sent to administrator.

The following models are defined for this example system.
Metrics
   PM1: Map1Output.ItemID=ItemOutStock.Item_ID
      PM2: Map2Output.OrderNumber=
      ProcurementOrder.OrderNumber Map2Output.LineItems=
      ProcurementOrder.LineItems
      PM3: Map3Output.OrderNumber=
      SupplierConfirmation.OrderNumber
         Map3Output.DeliveryDate=
      SupplierConfirmation.ExpectedDelivery
   PM4: Map4Output. Customer_Id=CustomerOrder.Customer_Id
      Map4Output.Item_Id=CustomerOrder.Item_Id
      Map4Output.DueDate=CustomerOrder.DueDate
      Map4Output.IsUrgent=CustomerOrder.IsUrgent
   PM5: Map5Output.Customer_Id=Map4Output.Customer_Id &
      Map5Output.Item_Id=Map4Output.Item_Id &
      Map5Output.CustomerID=Map4Output.CustomerID &
      Map5Output.duedate=Map4Output.duedate &
      Map5Output.DeliveryDate=Map3Output.DeliveryDate
      If
      ((Map4Output.IsUrgent==“True” &&
   (Map4Ouput.Item_Id belongs Map2Output.LineItems) &&
   (Map3Ouput.OrderNumber==Map2Output.OrderNumber) &&
   (Map4Ouput.duedate<Map4Output.DeliveryDate))
      Correlation Rules
PC1: A Block Duplicates correlation rule is defined for Map1. Since the ItemOutofStock message for one item may be sent several times by the monitor, we only need to report the message once to Map 5 and ignore all the following redundant messages for the same item.
PC2: An Update Last rule is defined for Map2. The procurement order may be issued several times. E.g. After sending the first replenishment order to supplier A, user may change the idea and want to send it to supplier B. In this case, two procurement order events with the same OrderNumber will be received. We need to ignore the first one and only consider the second one. A time window is used in this rule.
PC3: Same as Map2, an Update Last rule is also defined for Map3. For several Supplier Confirmation events with same OrderNumber within a period of time, we only consider the last one and ignore all previous ones.
PC4: A Match rule is defined for Map1 to filter out the Urgent Customer Order.
PC5: Another Match rule is also defined for Map 1 to extract customer information from outside data source and check whether customer's status is gold.
PC6: A Sequence (random order) correlation rule is defined for Map5. Only after all the messages from Map 1-4 have been received by Map5, it can use the metrics PM5 defined above to check whether a GoldCustomerorderDelayed situation exists or not.
   Action Model
PA1: Map1 Send Map1Output (ItemOutofStock) message to Map5;
PA2: Map2 Send Map2Output (ProcurementOrder) message to Map5;
PA3: Map3 Send Map3Output (SupplierConfirmation) message to Map5;
PA4: Map4 Send Map4Output (CustomerOrder) message to Map5;
PA5: Map5 Send Map5Output (GoldCustomerorderDelayed) message to Admin;

The PIM construction through interface matching is quite straightforward for this example. The constructed PIM DAG is shown in FIG. 10A. For process decomposition, basically, we consider each Map in FIG. 9 as a sub-process. The relationships between sub-processes are quite clear, as shown in FIG. 10B. Now we will show how to transform each sub-process into a BPEL process.
1. Partner definition: In the whole system, following partners will be used for one or more sub-processes.
Process Initializer: This partner is used to start/stop the process, once the process is started, it will continuously receiving messages from outside monitors and do corresponding actions;
Map1: BPEL process that implements sub-process 1;
Map2: BPEL process that implements sub-process 2;
Map3: BPEL process that implements sub_process 3;
Map4: BPEL process that implements sub-process 4;
Map5: BPEL process that implements sub-process 5. This is the main BPEL process for “Gold Customer Order Delayed” system. It takes inputs from Map 1-4, generates results and sends to administrator;
ItemOutOfStock Monitor: This monitor sends “ItemOutOfStock” message to BPEL process Map 1;
Procurement Order Monitor: This monitor sends “ProcurementOrder” message to BPEL process Map2;
Supplier Confirmation Monitor: This monitor sends “SupplierConfirmation” message to BPEL process Map3;
Customer Order Monitor: This monitor sends Customer Order message to BPEL process Map4;
Customer Information: A outside process/database that provides customer status information to BPEL process Map4;
Timer: An outside timer is used for BPEL process Map2&Map3 that have Update Last correlation rule. The timer is used to defer sending information to Map5 within a predefined period of time to wait for some updating;
Admin: The final “Gold Customer Order Delayed” information will be sent to this administrator by BPEL process Map5.

### Message Type Definition

| Message Type | Contents | Direction | Description |
|---|---|---|---|
| InitializeMsg | int command; (1: | Process Initializer | Start/stop BPEL process |
| | start; 0: stop) | → Maps1-4 | |
| ItemOutOfStockMsg | int Item_id; | ItemOutofStock | Get ItemOutofStock |
| | | Monitor → Map1 | information for one |
| | | Map1 → Map5 | particular item from |
| | | | monitor; andSend |
| | | | ItemOutofStock to |
| | | | Map5; |
| ProcureOrderMsg | int OrderNumber; | Procurment Order | Get replenishment |
| | Int[] lineItem; | Monitor → Map2 | information for a group |
| | | | of items |
| ProcureOutMsg | int OrderNumber; | Map2 → Map5 | Send out replenishment |
| | int Item_Id; | | information for one |
| | | | particular Item |
| SupplierConfirmMsg | int OrderNumber; | Supplier | Get |
| | DateTime: | Confirmation | SupplierConfirmation |
| | ExpectedDelivery; | Monitor → Map3 | information for one |
| | | Map3 → Map5 | particular OrderNumber |
| | | | from monitor; |
| | | | and |
| | | | Send |
| | | | SupplierConfirmation to |
| | | | Map5; |
| CheckCustomerMsg | int Customer_Id; | Map4 → Customer | Check customer status |
| | | Information | (Gold) |
| CustomerOrderMsg | int Customer_Id; | Customer Order | Get customer order |
| | Int[] LineItems; | Monitor → Map4 | information |
| | DateTime: | | |
| | Duedate; Boolean: | | |
| | IsUrgent; Int | | |
| | Order_Id; | | |
| GoldCustomerOrderDelay | int Customer_Id; | Map5 → Admin | Send |
| Msg | int Order_Id; | | GoldCustomerOrder |
| | int Item_Id; | | Delayed information to |
| | DateTime | | administrator |
| | Duedate; | | |
| | DateTime | | |
| | Deliverydate; | | |
| SetTimerMsg | int timeduration; | Map2/3 → Timer | Start timer |
| | (s)int | | |
| | OrderNumber; | | |
| TimerExpiredMsg | int OrderNumber; | Timer → Map2/3 | Send timer expired |
| | | | information back to |
| | | | BPEL process who set |
| | | | the timer |

The variables definitions for Sub-process 1, Get ItemOutofStock Information, are as follows:

| Name | Type |
|---|---|
| Initialization | IntializeMsg |
| ItemIn | ItemOutOfStockMsg |
| ItemOut | ItemOutOfStockMsg |
| OutofStockItem* | Int [ ] |

*Internal variable, which is an array that records the Item_id extracted from the ItemIn variable; e.g OutofStockItem[1] = ItemIn.Item_id;

This BPEL process, shown in FIG. 11, receives the “ItemOutofStock” messages from the partner “ItemOutOfStock Monitor” that monitors the Item-out-of-stock situation. In the implementation of Block Duplicates correlation rule, no timer needed. We only need to check whether the message with the give Item_id has already been received or not by checking whether the Item_id included in the message already exists in the OutofStockItem array. If it exists, do nothing. Otherwise append the Item_id to OutOfStockItem array and forward the message to Map5 process.

The variables definitions for Sub-process 2, Get ProcurementOrder Information, are as follows:

| Name | Type |
|---|---|
| Initialization | IntializeMsg |
| ProcureIn | procureOrderMsg |
| ProcureOut | procureOutMsg |
| SetTimer | SetTimerMsg |
| TimerExpired | TimerExpiredMsg |
| Order* | ProcureOrderMsg [ ] |

*Internal variable, which is an array that records the procurement order information; e.g Order[1].OrderNumber = ProcureIn.OrderNumber; Order[1].LineItem = ProcureIn.lineItem;

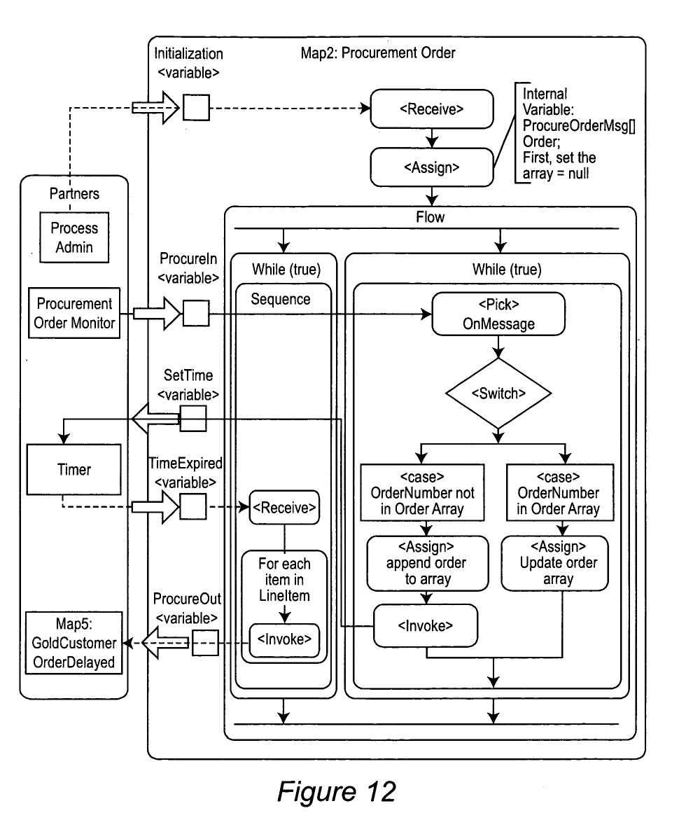

As shown in FIG. 12, once the Procurement Order message (ProcureIn) has been received, the process will check whether the OrderNumber included in the message already exists in the Order array. If it exists, update it with the new received one. Otherwise, append the message to Order array and start a timer with some specified time duration (e.g., five minutes). When the time expired, copy the item in order array to ProcureOut variable and send it to Map5 BPEL process for further operation. Since each item in order array contains a group of items (int[ ] LineItem), we want to extract each individual element from LineItem array and copy them to ProcureOut variable one by one. So for every item in order array, there will be several <invoke> activities, each for one element in the LineItem array.

The variables definitions for Sub-process 3, Get SupplierConfirmation

Information, are shown below:

| Name | Type |
|---|---|
| Initialization | IntializeMsg |
| ConfirmIn | SupplierConfirmMsg |
| ConfirmOut | SupplierConfirmMsg |
| SetTimer | SetTimerMsg |
| TimerExpired | TimerExpiredMsg |
| Confirm* | Int[ ] |

*Internal variable, which is an array that records the OrderNumber extracted from the ConfirmIn variable; e.g., Confirm[1] = ConfirmIn.OrderNumber;

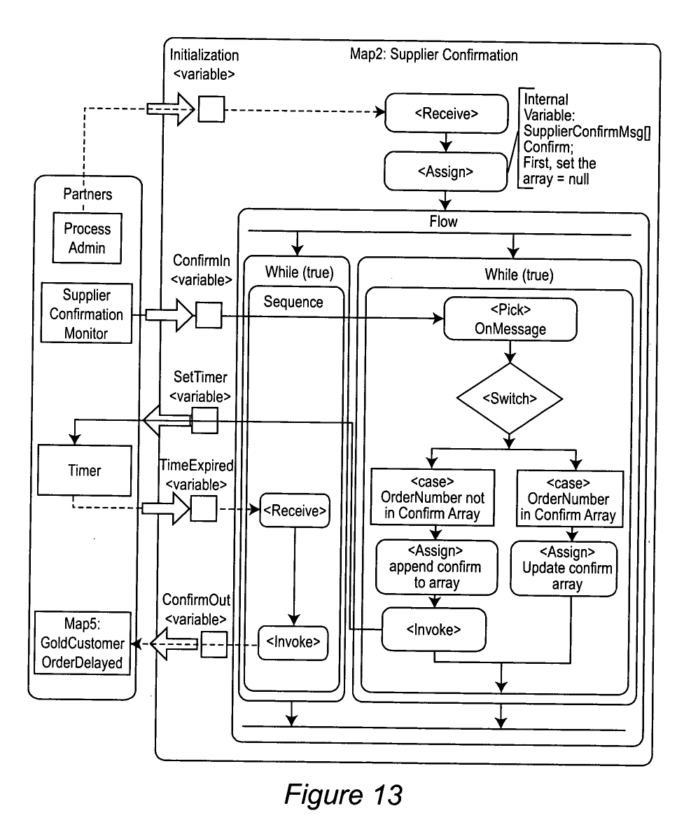

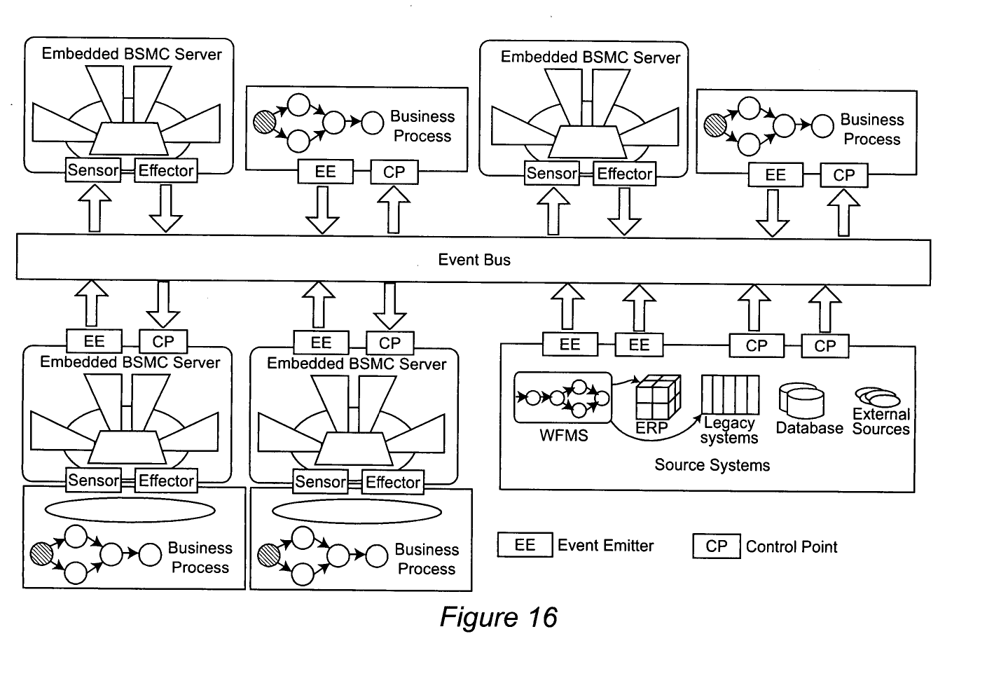

As shown in FIG. 13, the workflow for Process Map3 is exactly the same as Map2. Once the Supplier Confirmation message (ConfirmIn) has been received by the process, the process will check whether the OrderNumber included in the message already exists in the Confirm array. If it exists, update it with the new received one. Otherwise, append the OrderNumber to Confirm array and start a timer with some specified time duration. When the time expired, copy the item in Confirm array to ConfirmOut variable and send it to Map5 BPEL process for further operation FIG. 16.

The variables definitions for Map 4, Get Customer Order Information, are shown below:

| Name | Type |
|---|---|
| Initialization | IntializeMsg |
| CustomerOrder | CustomerOrderMsg |
| GCustomerUOrder | CustomerOrderMsg |

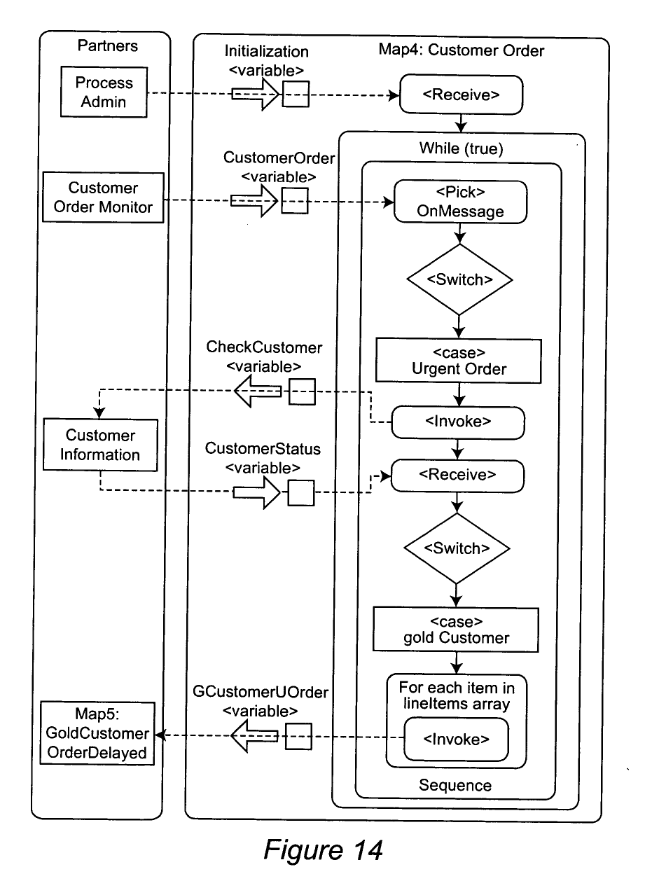

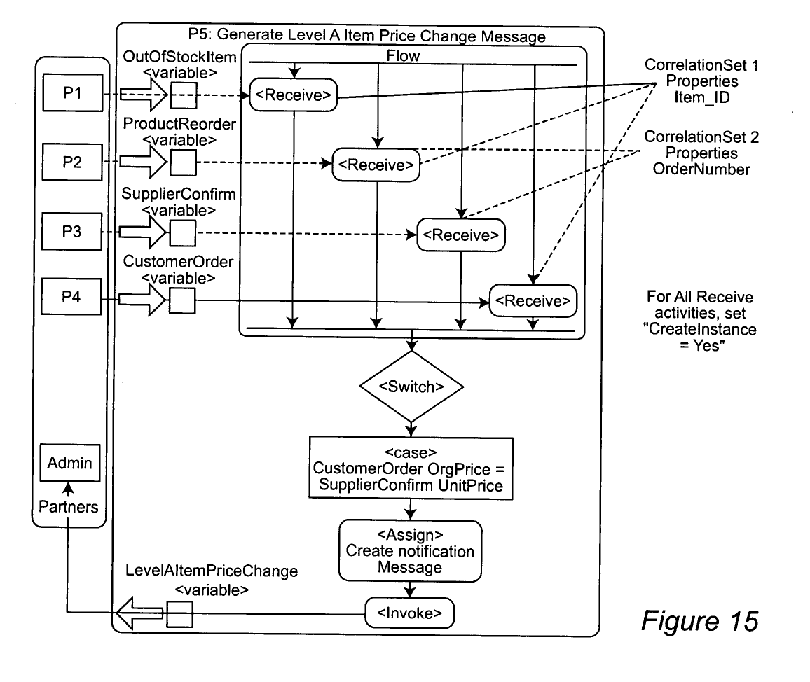

This BPEL process is shown in FIG. 14 and receives Customer Order events from Customer Order monitor that monitors the purchase orders from customers. The event contains:
Customer_Id: ID of the customer;
Item_Id: ID of the item customer wants to buy;
IsUrgent: Indicate whether this order is urgent or not;
Duedate: the date that customer expects to receive the item.
   Once receiving the customer order events, the process need to check whether the order is urgent or not (IsUrgent=True), all the non-urgent orders will be blocked. Then process retrieves customer information from customer information database to see the status of customer is gold or not. All the orders from customers that are not in gold status will also be blocked. Thus, two filters need to be used to filter unqualified orders out. Finally, the urgent order from gold customer will be forwarded to Map5 BPEL process for further operation.

The variables definitions for Map 5, Generate Gold Customer Order Delayed message, are shown below:

| Name | Type |
|---|---|
| OutofStockItem | ItemOutofStockMsg |
| ProcureOrder | ProcureOutMsg |
| SupplierConfirmation | SupplierConfirmMsg |
| CustomerOrder | CustomerOrderMsg |
| GoldCustomerDelayOrder | GoldCustomerDelayOrderMsg |

This BPEL process, shown in FIG. 14, is the core part of the whole Gold Customer Order Delayed process. It takes inputs from previous four BPEL processes (Maps 1-4) and checks whether an order delayed message needs to be sent or not.

The Correlation Set definition BPEL process has multiple start activities (<receive>). Each of them can create a process instance. There are four <receive> activities to receive the messages from Maps 1-4. These messages may arrive in any order. But unless all four messages that contain the same Item_Id (CustomerOrder, ItemOutofStock, ProcureOut messages that contain the same Item_Id; SupplierConfirmation message contains the OrderNumber that is the same as ProcurementOrder message) are received, we can make decision to see whether an order delayed message need be generated or not.

Since each of the four <receive> activities has the ability to create a new BPEL instance. Only the first triggered <receive> with the specific Item_Id (or OrderNumber) should create a new process instance, and others need to be correlated to the correct instance.

For four partners defined in Map5 (Maps 1-4), Map1 (ItemOutofStock), Map2(ProcurementOrder) and Map4(CustomerOrder) can be correlated by Item_Id, while Map2 and Map3(SupplierConfirmation) need to be correlated by OrderNumber. So ProcurementOrder is the only part that contains both Item_Id and OrderNumber and connects Map1, Map3 and Map4 together.

There are two correlation sets defined in Map5 BPEL process:

<correlationSets>

<CorrelationSet name=“ItemCorrelation” properties=“Item_Id”/>
   <CorrelationSet name=“OrderCorrelation” properties=
“OrderNumber”/>
   </correlationSets>

Then, in WSDL file of this BPEL process, following property and propertyAlias are defined (suppose the ios, co, po and sc indicate the service description file of Maps 1-4):

```
<Property name = “Item_Id” type=”xsd:int”>
<PropertyAlias propertyname = “Item_Id” messagetype=
    ”ios:ItemOutOfStockMsg” part=”Item_Id”>
<PropertyAlias propertyname = “Item_Id” messagetype=
    ”co:CustomerOrderMsg” part=”Item_Id”>
<PropertyAlias propertyname = “Item_Id” messagetype=
    ”po:ProcureOutMsg” part=”Item_Id”>
<PropertyAlias propertyname = “OrderNumber” messagetype=
    ”po:ProcureOutMsg” part=”OrderNumber”>
<PropertyAlias propertyname = “OrderNumber” messagetype=”
    sc:SupplierConfirmMsg” part=”OrderNumber”>
```

And in the <receive> activities, we can use the defined correlation set:

```
<receive name = “receive_out_of_stock_item” partnerLink =
      ”Itemoutofstock” ...createInstance = “yes”>
  <correlations>
    <correlation set = “ItemCorrelation” initiate = “yes”/>
  </correlations>
</receive>
<receive name = “receive_procure_order” partnerLink =
      ”procureorder” ...createInstance = “yes”>
  <correlations>
    <correlation set = “ItemCorrelation” initiate = “yes”/>
    <correlation set = “OrderCorrelation” initiate = “yes”/>
  </correlations></receive><receive name =
      “receive_supplier_confirmation” partnerLink =
      ”supplierconfirmation” ...createInstance = “yes”>
  <correlations>
    <correlation set = “OrderCorrelation” initiate = “yes”/>
  </correlations>
</receive>
<receive name = “receive_customer_order” partnerLink =
      ”customerorder” ...createInstance = “yes”>
  <correlations>
    <correlation set = “ItemCorrelation” initiate = “yes”/>
  </correlations>
</receive>
```

So when the message comes, the BPEL process will check whether there is an instance with the given correlation set already exist or not. If it exists, the received messages will be correlated to that instance and continue the operation. Otherwise, a new BPEL instance will be created.

After receiving all four messages from partner Maps 1-4, we can check to see whether an Goldcustomerorderdelay message need be generated. The conditions for generating a Gold Customer Order Delayed message are:

1) Customer requested Item is out of stock;

CustomerOrder.Item_Id==OutOfStockItem.Item_Id;
   2) A procurement order for that Item has been sent;
OutOfStockItem.Item_Id I ProcureOrder.lineItem;
   3) Supplier gives response to the procurement order;
SupplierConfirmation.OrderNumber==ProcureOrder.OrderNumber;
   4) Supplier's delivery date is later than customer requested duedate.
CustomerOrder.DueDate<SupplierConfirmation.ExpectedDelivery.
   If all the above four conditions are satisfied, a Gold Customer Order Delayed message needs to be generated and sent to Administrator.

FIG. 16 shows an apparatus of business solution monitoring and control systems (BSMC) using model-integrated approach according to the invention. Different roles can define their monitoring and control intentions based on their demands and expertise. This invention provides a means of helping users define such intentions, composing the user inputs into formal yet light-weight solution models, partitioning the solution models into smaller and executable units that can be deployed to the runtime automatically. FIG. 16 represents an example of the runtime after the invention has been applied by users and supporting tools. Each BSMC server represents an executable unit that receives and configures incoming monitoring and control models out of the decomposition process. A BSMC server can be standalone or embedded into a business process. They communicate with one another through an event bus which enables asynchronous communications among them. The BSMC servers and business processes also communicate with source systems through the even bus.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A model-driven method for Business Solution Monitoring and Control environments comprising the steps of:
describing business-level monitoring and control requirements by a high level abstract model, which is independent from platform and implementation technologies;
presenting the high level abstract model as a Directed Acyclic Graph (DAG) that is constructed by a series of models described as logical expressions; and
decomposing the high level abstract model into several sub-processes that can be easily transformed into an executable representation that is deployed at runtime.

2. The model-driven method recited in claim 1, wherein the series of models is described in a markup language.

3. The model-driven method recited in claim 2, wherein the markup language is XML (eXtensible Markup Language).

4. The model-driven method recited in claim 1, wherein the executable representation is BPEL (Business Process Execution Language).

5. The model-driven method recited in claim 1, wherein the executable representation is JAVA

6. An apparatus of business solution monitoring and control systems (BSMC) using model-integrated approach comprising:
one or more BSMC servers on which are described business-level monitoring and control requirements by a high level abstract model, which is independent from platform and implementation technologies;
means connected to said servers for presenting the high level abstract model as a Directed Acyclic Graph (DAG) that is constructed by a series of models described as logical expressions; and
means in said servers for decomposing the high level abstract model into several sub-processes that can be easily transformed into an executable representation that is deployed at runtime

7. The apparatus recited in claim 6, further comprising:
an event bus providing asynchronous communication among a plurality of BSMC servers; and
source systems connected to said event bus and accessed by said BSMC servers.

8. A machine readable product containing computer code which implements the method comprising the steps of:
describing business-level monitoring and control requirements by a high level abstract model, which is independent from platform and implementation technologies;
presenting the high level abstract model as a Directed Acyclic Graph (DAG) that is constructed by a series of models described in a programming language; and
decomposing the high level abstract model into several sub-processes that can be easily transformed into an executable representation that is deployed at runtime.

9. The machine readable product recited in claim 8, wherein the series of models is described in a markup language.

10. The machine readable product recited in claim 9, wherein the markup language is XML (extensible Markup Language).

11. The machine readable product recited in claim 8, wherein the executable representation is BPEL (Business Process Execution Language).

12. The machine readable product recited in claim 8, wherein the executable representation is JAVA.
